(19) United States
(12) Patent Application Publication
(10) Pub. No.: US 2005/0076488 A1
(43) Pub. Date: Apr. 14, 2005

(54) Method and device for obtaining a determined flow resistance of a flow channel

(76) Inventors: Peter Gosger, Solingen (DE); Armin Walther, Kaufbeuren (DE); Patrick Matt, Marktoberdorf-Leuterschach (DE); Alfred Ernst, Sontheim (DE)

Correspondence Address: James G Porcelli, 700 Koppers Building, 436 Seventh Avenue, Pittsburgh, PA, 15219-1818, US

(21) Appl. No.: 10/503,447

(22) PCT Filed: Jan. 23, 2003
(86) PCT No.: PCT/EP03/00634

(30) Foreign Application Priority Data
Feb. 4, 2002 (DE) 102 04 952.1

(51) Int. Cl. B23Q 17/00; G01M 19/00

(52) U.S. Cl. 29/407.08; 29/407.05; 29/705

(57) ABSTRACT

A diagnostic reagent for use in the evaluation of a pharmacological effect of a medicine containing a pharmaceutical agent including an enzyme, an enzyme inhibitor or a receptor ligand or a prodrug of the pharmaceutical agent; and a method of screening pharmaceutical agents each comprising an enzyme, an enzyme inhibitor or a receptor ligand and/or prodrugs of the pharmaceutical agents for one or noes having high medicative efficacy and/or a small side effect are provided. The diagnostic regent and the reagent used in the method comprise: (a) a compound which serves as a substrate for the enzyme contained in the medicine or the pharmaceutical agent to be evaluated or for an enzyme generated from the prodrug contained in the medicine or the pharmaceutical agent to be evaluated, or a pharmaceutically acceptable salt thereof; (b) a compound which serves as a substrate for a different enzyme capable of exhibiting an alteration in activity by coupling to the effect of the enzyme in (a), or a pharmaceutically acceptable salt thereof; (c) a compound which serves as a substrate for an enzyme which is directly inhibited by the enzyme inhibitor contained in the medicine or the pharmaceutical agent to be evaluated or by an enzyme inhibitor generated from the prodrug contained in the medicine or the pharmaceutical agent to be evaluated, or a pharmaceuticcallly acceptable salt thereof; (d) a compound which serves as a substrate for an enzyme capable of exhibiting an alteration in activity by coupling to the effect of the enzyme inhibitor in (c), or a pharmaceutically acceptable salt thereof; (e) a compound which serves as a substrate for an enzyme capable of exhibiting an alteration in activity by the binding between a receptor

This invention relates to a method and device for obtaining a determined flow resistance of a flow channel, in particular of an opening in a component.

This invention relates in general to the machining and sizing of flow channels, in particular of openings or mouths, and preferably of small openings, where it is necessary to achieve a critical flow resistance, as well as the correct balancing of flow resistances in a number of such flow channels.

The significance of the flow resistance of a flow channel is well known. Examples include, among other things, fuel injector nozzles, spray nozzles, the flow of cooling air through components of turbines, the dosing of lubricating oil for precision bearings etc. In many such applications an exact dosing of flows is of very great significance, but as a result of manufacturing limitations it likewise involves significant problems. Even very small differences in the manufacturing tolerances can cause major changes in the flow resistance and in the flow.

Moreover, parts are frequently cast or fabricated from a material that is selected for specific properties such as its conductivity or insulating action for heat or electricity, low weight, a coefficient of expansion during heating or cooling, cost etc., although there is a different set of requirements regarding the inside surface of the opening. These particular requirements for the inside of the passage can be met by plating or coating with a metal that has the desired characteristics. Plating can be done by electroplating or electroless (autocatalytic) plating, while the coating can also be done by vacuum metallizing or the use of a carrier gas or another such technology. Electroless plating or vacuum metallizing is generally used to plate or coat the inner surface of castings, borings etc., where secondary cathodes for a uniform electroplating are difficult to place.

Parts with flow openings for a fluid are manufactured by a variety of casting and machining operations. For example, high-quality precision molding methods can be used for the fabrication of these parts. Nevertheless, there are certain differences in the dimensions of such parts, in particular with regard to wall thicknesses, which are due to minor alignment errors in the core or the result of a displacement of the core, as well as fluctuations in the surface characteristics, in particular the roughness of the surface, small pits, nicks, grooves, blisters or positive metal. In the extreme case, a very small crack in the core can result in a thin wall which projects into an inner passageway. All these factors can significantly alter the flow of the fluid.

Machining methods that are in current use, such as electrical erosion machining and laser drilling, or less common technologies such as drilling by means of an electron beam, electrical current and STEM drilling (an ECM technology that uses an acid fluid) are not sufficiently precise to prevent significant changes in the flow resistance. Even the most accurate of these methods, electroerosion machining, will not achieve a perfectly uniform flow resistance, because the length of an internal passageway can vary as a result of the machining method used, and can in turn cause fluctuations in the overall length of the hole and of the flow resistance, regardless of the uniformity of the diameter of the hole. Furthermore, non-uniform conditions are unavoidable in electroerosion machining and can result in variations in the size, shape, surface and condition at the edge of the hole.

Openings to be plated or coated must be sufficiently oversized to leave room for a corresponding thickness of the plating or of the coating, and the ultimate precision depends on the exact calculations for the plating or coating rates and on the accuracy of the drilling and plating operations. The product that can be achieved using current technology is not sufficiently uniform for most precision industrial applications. Thus there are restrictions on the choice of methods available to the manufacturer for the fabrication of the overall part from materials that have the properties desired for the opening or for the embedding of drilled parts with specified properties in castings that have been realized to receive them. These technologies have the precision problems related to drilling described above. The plating of openings that are bored into a material with metal that has different characteristics or even with the same metal, which results in a precision flow, opens up a whole new range of possibilities in the manufacture of many parts.

In many applications, the variances that are inherent to the drilling operations can be accepted within broad limits, and the related compromises regarding freedom of design, construction and performance are simply accepted as inevitable. For example, the delivery of measured quantities of fuel in internal combustion engines by pressure injection of the fuel requires the measured discharge of the flow through nozzles.

Greater accuracy in the regulation of the flow will make possible an improved utilization of the fuel, as well as increases in the economy and precision of the operation of the engine. The realization of fuel dosing systems of this type in current use is frequently based on the measurement of the actual flow resistance and a distribution of the inventories in ranges of flow parameters, to achieve an at least approximate matching of parts in an inventory within a range of deviation of specified tolerances. A method of this type is extremely complex on account of the significant inventory requirements. A significant number of parts also fall outside the range of the allowable deviations and must be reprocessed at great expense or rejected.

In the past, fuel injection nozzles were fabricated so that the critical dosing openings for the flow were formed by electroerosion machining, Because a number of components have flow channels that are becoming increasingly smaller and must be calibrated, i.e. set to a specified flow resistance, homogenization, essentially of the inlet edge of the flow channel, is becoming increasingly important, because the smaller the dimensions of the flow channel, the less appropriate mechanical machining methods become.

Another example in which the flow resistance of an opening is of critical importance is the creation of a cooling flow through gas turbine components such as turbine blades. Turbine blades manufactured using precision casting techniques are typically cast or drilled (by means of laser drilling, STEM drilling or electroerosion machining) so that a number of holes are created that typically have a nominal diameter of approximately 0.3 mm to 0.8 mm and extend from the internal passageway to the vicinity of the leading edge of the profile, the trailing edge of the profile or any point along the blade profile. To cool the blades, cooling air is displaced from the interior through the numerous holes into a current of high-temperature combustion gas. During this process, holes in the inner walls of the blades apportion the distribution of the cooling air. It is obvious that changes in the flow resistance can result in differences in the cooling action, which can lead to hot spots that alter the thermal equilibrium inside the components and the engine itself and can influence both the performance and the useful life of the components. The use of cooling air should be minimized, however, because the excessive use of cooling air reduces the efficiency of the engine by “stealing” energy from the compressor stage. When components of this type are used, a more precise control of the flow resistance of these passageways can result in a significant gain in efficiency of both the components and the units in which said components are integrated.

In addition to heads for fuel injector nozzles, spray nozzles, for the flow of cooling air through components of turbines and for the delivery of measured quantities of lubricating oil for bearings, there are numerous other uses of passageways or openings that are used to regulate or control a flow in which this invention can be used.

EP 0 441 887 B1 describes a method of the prior art for the treatment of openings to achieve a determined flow resistance in which a working fluid with which an opening is being machined flows through an opening and at a constant pressure (alternatively: constant flow rate) the flow rate (alternatively: varying pressure) that varies during the machining is measured. As soon as the flow rate reaches a determined value or the pressure drops to a determined value, the machining process is interrupted. Of course, with this method flow resistances of the opening with regard to a fluid can be set accurately, although the specification of a constant pressure or a constant flow rate turns out to be complicated and time-consuming.

The object of this invention is therefore to create an improved method to achieve a specified flow resistance of a flow channel and a simplified device that is suitable in particular for the performance of the method, by means of which a flow channel of a component can be accurately calibrated with respect to its flow resistance and which specifically uses structurally less complex and expensive means than similar methods of the prior art.

The invention teaches a method that is characterized by the features disclosed in Claim 1 and a device that is characterized by the features disclosed in Claim 14. Advantageous realizations and developments of the invention, which can each be used individually or in any desired combination with one another, are the objects of the respective dependent claims.

The method claimed by the invention to achieve a determined flow resistance of a flow channel, in particular of an opening in a component, comprises the following steps: a fluid flows through the flow channel; a parameter is determined which is a function of the flow resistance of the flow channel in the component; the flow channel is machined using a working machine until the parameter reaches a specified set point; and is characterized by the fact that the parameter is determined from a first measured variable and from a second measured variable, whereby it is permissible for the first measured variable and the second measured variable to change over time.

The flow resistance of the flow channel can be understood by analogy to the resistance of an electrical conductor. In general, the flow resistance of the flow channel counteracts the flow of a fluid that flows through the flow channel. Consequently, when a pressure difference is applied to the ends of the flow channel, a fluid flow through the flow channel flows at a determined flow rate, whereby the flow rate is determined by the flow resistance. For example, the flow resistance can be defined, for example, by the quotient of the pressure difference that decreases over the flow channel and the flow rate. The flow rate can be measured in different units, depending on the application, e.g. the units for a volume flow, a mass flow or a particle flow.

By determining two measurement variables, a parameter is defined that represents a yardstick for the flow resistance. The parameter need not be proportional to the flow resistance. It suffices if the parameters is only a function of the flow resistance. Preferably an unambiguous relationship between the flow resistance and the parameter exists, although particular preference is given to a one-to-one correspondence. The parameter can be a non-linear function of the flow resistance.

The measured variable can be the pressure difference acting across the flow channel as well as the flow rate through the flow channel. The flow rate can be determined by means of a calibrated resistance and a pressure measurement. It is also possible for at least one of the two measured variables to be determined by a combination of a pressure measurement and a flow rate measurement. That is the case, for example, when an output is measured. Power, as it is defined in electrical engineering is analogous in fluid dynamics to the product of pressure and the flow rate. The term “measured variable” is therefore used in its general sense. It is important that two measured variables are measured to be able to compensate for the fluctuation over time, so that a measurement of the type represented by the parameter can be found for the flow resistance through the flow channel.

The variations over time are eliminated by forming for the determination of the parameter a quotient of the flow rate measured at a determined time and the pressure measured at a determined time. In the opposite direction, this makes it possible to accept a very much higher fluctuation tolerance in the determination of the parameters and fluctuations or variations over time, without any negative impact on the calibration of the flow channel. Consequently, means to stabilize the pressure or flow rates become superfluous, as a result of which the method can be significantly simplified and more reliable, as well as more economical.

The flow channel is machined using a working method until the parameter reaches a specified set point. The working method for the machining of the flow channel is advantageously selected from the group that includes chemical machining, hydroabrasive machining, mechanical machining, electrochemical machining (ECM), electroerosion machining, electroplating, electroless plating, coating and vacuum metallizing. With these working methods, small flow channels with opening diameters of a few tenths of a micrometer can be accurately machined and calibrated in connection with the method claimed by the invention, whereby the geometric dimensions of the flow channel are modified so that, depending on the working method selected, the flow resistance increases or decreases during the machining, and whereby by means of the method claimed by the invention flow resistances of a flow channel, for example of spray nozzles or gas turbine components, can be accurately calibrated with tolerances of better than 1%.

In one preferred embodiment, the measured variable is determined by the measurement of a pressure or by the measurement of a flow rate or by the measurement of a combination of pressure and flow rate. A combination of pressure and flow rate, for example, represents an output that is the product of the pressure and flow rate. The quotient for the determination of the parameters can also be determined with a pressure measurement and an output measurement.

The measurement of a pressure of the fluid can be taken with reference to the ambient atmospheric pressure. Conventional average pressures for the machining of the component on devices conventionally made of high-grade steel are preferably above 20 bar, in particular above 50 bar, and particular preference is given to pressures above 70 bar.

Alternatively, the invention teaches an average machining pressure between 3 and 8 bar, preferably 4 and 6 bar and in particular 5 bar, whereby depending on the selected pressure, it is also possible to use either special or conventional plastics in industrial applications, i.e. in particular to fabricate the feed lines from commercial PVC tubing.

It is advantageous if both measured variables are measured upstream of the flow channel in the direction of flow of the fluid and/or in pauses during the machining. By measuring a measured variable upstream of the flow channel in the flow direction of the fluid, it can be ensured that particles that detach from the component cannot adversely affect the measurement, and in particular that they cannot stick to the sensors or cause errors in the measurement of the flow rate as a result of fluctuations in the density of the fluid associated with the parties. By measuring the measured variables during pauses in the machining, i.e. in periods of 3 to 5 seconds, during which no electrical voltage is applied between the cathode and the component and no materials is being removed, the machining process can be advantageously influenced. The invention teaches in particular that the cathode(s) are also briefly removed from the flow channels during the pauses in machining, to eliminate the characteristic of the fluid that varies during a machining operation with regard to its flow on one hand and with regard to its reaction to iron hydroxide and hydrogen on the other hand.

In one advantageous embodiment of the method claimed by the invention, the set point for a specifiable average flow rate and/or for a specifiable average pressure is determined. It is thereby ensured that the parameter represents a reasonable measurement for the flow resistance and errors in the determination of the parameter resulting from non-linear flow characteristics, e.g. resulting from turbulences at high flow rates, can be avoided. To achieve a high measurement accuracy, it is advantageous to avoid non-linear disruptions it is advantageous if the range of fluctuations of the fluctuations over time is less than the average fluctuation, in particular less than 30%, preferably less than 20% of the average fluctuation.

In one preferred configuration of the method claimed by the invention, the set point is determined by means of a master object. For this purpose, the flow channel is replaced by the master object and the parameter is then determined. By means of the master object, a desired flow resistance and thus the set point for the parameter can be specified. As the method is carried out, the flow channel is machined until the parameter and thus the flow resistance of the flow channel are exactly equal to that of the master object.

In one special configuration of the method claimed by the invention, at least one of the two measured variables is determined by means of at least one specified resistance. It is thereby possible in particular to supplement a measurement of the flow rate with a measurement of a pressure. A pressure measurement can be performed economically and accurately by means of commercial means, such as by means of a piezometer, for example.

The invention teaches that preferably, the variation of the amplitudes of both measured variables over time is greater than 1%, in particular greater than 5%, and preferably greater than 15%.

Therefore it is appropriate if, for the determination of the measurement variables, detectors are used, the response time of which is less than the typical time constants of the fluctuation of the flow rate and/or of the pressure. This feature ensures that the detectors fully measure the fluctuations over time and therefore that no errors in the measured variables will occur and thus in the determination of the parameter on account of averaging over time. The response time of the detectors is preferably less than the clock frequency of the device required for the movement of the fluid, such as, for example, a pump. The response time of the detectors is preferably in the range of milliseconds.

The fluids used appropriately include electrolytic solutions, corrosive fluids, acids, lyes, dielectric fluids and/or carrier gases. Using fluids of this type flow channels, e.g. openings or other cavities where access is difficult can advantageously be machined from the inside.

The parameters are advantageously determined by means of a lock-in method. For this purpose, the pressure of the fluid flowing through the flow channel and/or the flow rate through the flow channel is modulated with a modulation frequency and the parameter is subjected to a frequency-selective analysis and amplification at the corresponding modulation frequency. To generate the modulation, it is advantageous to use the pump that is used to transport the fluid. For example, a piston pump specifies a modulation frequency by its frequency of rotation. Using the lock-in method, the noise of the detectors and/or of the electronic components (e.g. thermal noise) can be suppressed to a significant extent. The signal-to-noise ratio and thus the tolerances that can be achieved with the method in the calibration of flow channels can be improved by a factor of 100 to 1000.

The device claimed by the invention to achieve a determined flow resistance of a flow channel, in particular an opening in a component, preferably for the performance of the method claimed by the invention, comprises a device for the generation of a fluid current, a fluid reservoir, a pressure sensor, a flow rate sensor and a fluid reservoir, whereby a first line connects the fluid reservoir with the device for the generation of a fluid flow and a second line connects the device for the generation of a fluid flow with the flow channel, and is characterized by determination means for the dynamic determination of a parameter that characterizes the flow resistance of the flow channel.

The device claimed by the invention therefore does not require any components to stabilize the pressure or flow rates as taught in the prior art. The determination means determine from the data that the pressure sensor and the flow rate sensor supply a parameter that is representative of the flow resistance of the flow channel. By forming the quotient of the pressure and flow rate, the parameter is corrected for the temporal fluctuations. The determination means preferably comprise a computing unit for the formation of a quota. It represents one portion, for example, of a control unit which, on the basis of data from at least two detectors, determines a parameter with which the working method to machine the flow channel can be regulated.

In one advantageous realization of the invention, the flow rate sensor comprises a resistance and a pressure measurement device which are connected in parallel. As a result of the parallel connection of a resistance and a pressure measurement device, by means of a pressure measurement the flow rate can be determined, as a result of which it is easily possible to determine the flow rate required for the determination of the parameter.

To prevent disruptions or measurement errors that can be caused for example by a detachment of particles from the component during the machining process, both the pressure sensor and the flow rate sensor are located upstream of the flow channel in the direction of flow of the fluid.

The device claimed by the invention advantageously comprises a lock-in amplifier to improve the signal-to-noise ratio of the measured variables and thus of the parameter. The parameter is thereby analyzed and amplified on a frequency-selective basis at a modulation frequency. For this purpose, the device includes a modulation frequency generator that modulates the flow rate through the flow channel or the pressure of the fluid upstream of the flow channel with a modulation frequency. A sensor measures the modulation frequency at the modulation frequency generator for the lock-in amplifier. The modulation frequency generator is advantageously the pump that is used to deliver the fluid.

Additional advantages and details of the invention are explained in greater detail below with reference to the purely exemplary embodiment that is illustrated in the accompanying schematic drawings, in which:

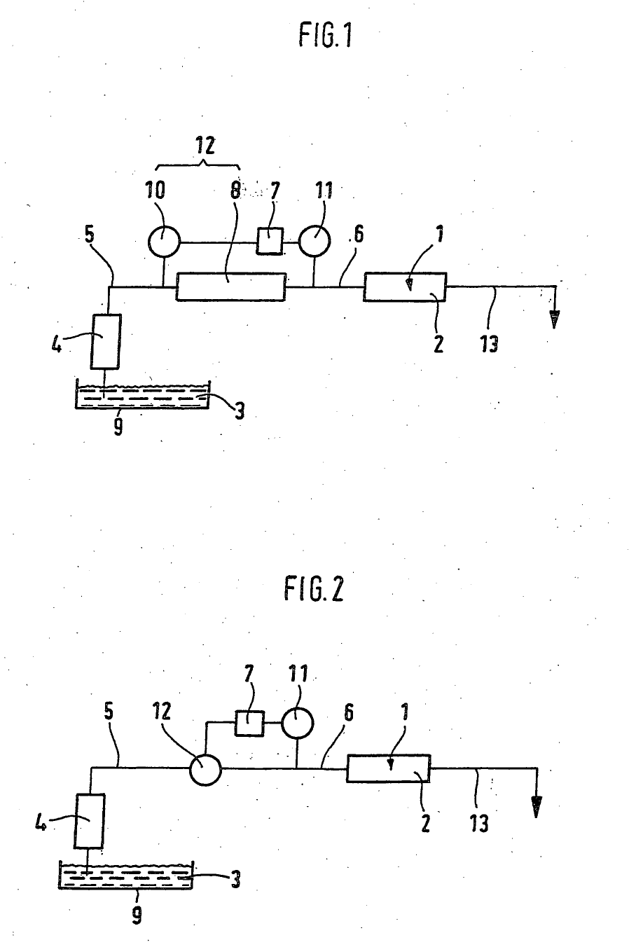

FIG. 1 illustrates a first exemplary embodiment of the device claimed by the invention to achieve a determined flow resistance, and

FIG. 2 illustrates an additional device as claimed by the invention.

FIG. 1 shows a first exemplary embodiment as claimed by the invention to achieve a determined flow resistance of a flow channel 1, in particular an opening in a component 2, with a fluid reservoir 9, a device 4 to generate a fluid flow, for example a generator, a pump, a pressure reservoir or similar device, a pressure measuring device 10 with a resistance 8 and a pressure sensor 11. The fluid 3 is pumped out of the fluid reservoir 9 by means of a piston pump 4, for example, via a first line 5 and a second line 6 through the flow channel 1 of the component 2. The pressure measurement device 10 with the resistance 8 represents a flow rate sensor 12. From the data supplied by the flow rate sensor 12 and the pressure sensor 11, the determination means 7 determine a parameter. The pressure that declines over the flow channel 1 is thereby preferably divided by the flow rate of the fluid flowing through the flow channel 1. The fluctuations over time are thereby eliminated and the parameter can be used as a yardstick for the flow resistance of the flow channel 1.

The fluid 3 flowing out of the flow channel 1 flows out via a discharge 13 or is released directly into the open air. The sequence of the pressure sensor 11 and of the flow rate sensor 12 can be selected as a function of the type or selection of the sensors 11, 12 and the type of measurement. It is advantageous, however, if both sensors 11, 12 are located upstream of the component 2 in the direction of flow of the fluid 3. By the measurement of the pressure as it varies over time or of the flow rate as it varies over time by means of the pressure sensor 11 and the flow rate sensor 12 respectively, a parameter can be determined which represents a precise measurement for the flow resistance of the flow channel 1. In particular, it thereby becomes possible to tolerate fluctuations of the type that can be generated by the pump 4, for example. The determining means 7 eliminate the fluctuations from the data collected by the pressure sensor 11 and/or the flow rate sensor 12.

FIG. 2 shows an alternate realization of the device claimed by the invention, like the one illustrated in FIG. 1, to obtain a determined flow resistance of a flow channel 1, with the distinction that the flow rate is measured directly by the flow rate sensor 12.

This invention relates to a method to obtain a determined flow resistance of a flow channel 1, in particular of an opening in a component 2, and comprises the following steps: a fluid 3 flows through the flow channel 1; a parameter is determined which is a function of the flow resistance of the flow channel 1 in the component 2; the flow channel 1 is machined with a working method until the parameter reaches a specified set point and is characterized by the fact that the parameter is determined from a first measured variable and a second measured variable, whereby the first measured variable and the second measured variable can change over time.

The method claimed by the invention as well as the device suitable for the performance of the method claimed by the invention are characterized by, among other things, the fact that a determined flow resistance of a flow channel in components such as spray nozzles or gas turbine blades can be achieved with a high degree of precision, without either special design and construction requirements for the characteristics of the device used for the production of a fluid current or means to stabilize the pressure or flow rates, as suggested in the prior art.

Nomenclature

1 Flow channel
2 Component
3 Fluid
4 Device to produce a fluid flow
5 First line
6 Second line
7 Determination means
8 Resistance
9 Fluid reservoir
10 Pressure measurement device
11 Pressure sensor
12 Flow rate sensor
13 Discharge

1-18. (canceled)

19. A method to achieve a determined flow resistance of a flow channel, in particular of an opening in a component, comprising the steps listed below:
a fluid flows through the flow channel;
a parameter is determined which is a function of the flow resistance of the flow channel in the component;
the flow channel is machined with a working method until the parameter has reached a specified set point;
wherein
the parameter is determined from a first measured variable and a second measured variable, whereby the first measured variable and the second measured variable can change over time.

20. The method as claimed in claim 19, wherein the working method is selected from the group consisting of chemical machining, hydroabrasive machining, mechanical machining, electrochemical machining, electroerosion machining, electroplating, electroless plating, coating and vacuum metallizing.

21. The method as claimed in claim 19, wherein the measured variable is determined by measurement of a pressure or by measurement of a flow rate or by measurement of a combination of pressure and flow rate.

22. The method as claimed in claim 19, wherein the average machining pressure is between 3 and 8 bar, preferably between 4 and 6 bar, and in particular 5 bar.

23. The method as claimed in claim 19, wherein a measurement is performed during a machining pause when the flow channel is free of an inserted cathode, or is at least free of an applied electrical voltage.

24. The method as claimed in claim 19, wherein both measured variables are measured upstream of the flow channel in the direction of flow of the fluid.

25. The method as claimed in claim 19, wherein the set point is determined for a specifiable average flow rate and/or for a specifiable average pressure.

26. The method as claimed in claim 19, wherein the set point is determined by means of a master object.

27. The method as claimed in claim 19, wherein at least one of the two measured variables is determined by means of at least one specified resistance.

28. The method as claimed in claim 19, wherein the variation of the amplitudes of both measured variables over time is greater than 1%, in particular greater than 5%, preferably greater than 15%.

29. The method as claimed in claim 19, wherein for the determination of the measured variables, sensors are used, the response time of which is less than the typical time constant of the fluctuations of the flow rate and/or of the pressure.

30. The method as claimed in claim 19, wherein the fluid comprises electrolytic solutions, corrosive fluids, dielectric fluids and/or carrier gases.

31. The method as claimed in claim 19, wherein the parameter is determined by means of a lock-in method.

32. A device to achieve a determined flow resistance of a flow channel in a component, comprising a device for the generation of a fluid current, a pressure sensor, a flow rate sensor and a fluid reservoir, whereby a first line connects the fluid reservoir with the device for the generation of a fluid current, and a second line connects the device for the generation of a fluid current with the flow channel, and a determination means for the dynamic determination of a parameter that characterizes the flow resistance of the flow channel.

33. The device as claimed in claim 32, wherein the flow rate sensor comprises a resistance and a pressure measurement device that are connected in parallel.

34. The device as claimed in claim 32, wherein both the pressure sensor as well as the flow rate sensor are located in the second line upstream of the flow channel in the direction of flow of the fluid.

35. The device as claimed in claim 32, wherein at least the lines are fabricated from a plastic material.

36. The device as claimed in claim 32, further including a lock-in amplifier to improve the signal-to-noise ratio of the measured variables.
